(19) United States
(12) Patent Application Publication
(10) Pub. No.: US 2003/0127078 A1
(43) Pub. Date: Jul. 10, 2003

(54) Exhaust gas recirculation device for an internal combustion engine

(75) Inventor: Marcel LeFoll, Ambleny (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: Qualetude, Oulchy-le-Chateau (FR)

(21) Appl. No.: 10/316,802

(22) Filed: Dec. 11, 2002

(30) Foreign Application Priority Data
Dec. 11, 2001 (FR) FR 01/15992

(51) Int. Cl. F02M 25/07

(52) U.S. Cl. 123/568.11

(57) ABSTRACT

The present invention pertains to an exhaust gas recirculation device (1) for an internal combustion engine of the type comprising a tubular part (2) for passage of said gases and a connector (5, 6) at each of its ends (3, 4), characterized in that at least one connector (5, 6) presents at least one circular corrugation ridge (7) for the absorption of vibrations.

The present invention also pertains to a connector (5, 6) for an exhaust gas recirculation device (1) for an internal combustion engine according to the invention.

The present invention pertains to the field of exhaust gas recirculation devices for internal combustion engines.

The present invention pertains more specifically to an exhaust gas recirculation device for an internal combustion engine of the type comprising a tubular part for the passage of said gases and connectors at both of its ends.

Exhaust Gas Recirculation (EGR) devices for internal combustion engines are already known in the prior art.

These devices are especially used in the automotive industry for recirculation of exhaust gases so that a second combustion can be performed in order that the polluting components such as the nitrogen oxides (NOx) contained in these gases are completely burned.

These devices are often made of a single piece composed of a central tubular part with a joining collar at each of its ends. The tubular part is comprised of a succession of smooth and corrugated external wall parts.

Known in the prior art, for example, is the German utility patent no. DE 295 16 861 which pertains to an exhaust gas recirculation device for an internal combustion engine of the type comprising two tubular parts (1) for passage of said gases. The described and claimed device is constituted by a case (4) comprising a junction element (2) designed to enable formation of extraction on a straight duct. In other words, the disclosed device is an extraction element of the “T” type enabling extraction of part of the gases circulating in a duct which is originally a straight duct. This illustrated recirculation device thus has a connector in its center.

Also known in the prior art is European patent application no. EP 647 779 which pertains to an exhaust gas recirculation device for an internal combustion engine of the type also comprising two tubular parts (1, 2) for passage of said gases. In fact, it is stated in column 3, lines 9 to 12 that “a part of the exhaust gases from the engine are taken into the exhaust manifold by a metal duct (2) which recirculates them in the air intake manifold (1) of the engine”. Since only a part of the exhaust gases are taken into the duct (2), the ends of the recirculation device itself are located opposite to the illustrated ends of the ducts and the document thus discloses a recirculation device comprising a central connector.

Also known in the prior art is European patent application no. EP 759 502 which pertains to a central extraction element which is essentially similar in its principle to the extraction element illustrated in German utility model no. DE 295 16 861.

The exhaust gas recirculation devices must satisfy different functions:

transport the gases in a tight manner,

provide a rarely rectilinear path between the two elements to be connected,

compensate for the side dispersions due to the assembly of the engine elements so as to enable the joining together of the two elements, and

absorb the vibrations due to the operation of the drive train.

Thus, the corrugation ridges have three functions:

enable bending of the tubular part,

compensate for side dispersions, and

absorb vibrations.

In the meantime, the evolution of manufacturing techniques has made it possible to create directly a tubular central part constituted by a single tube with a smooth external wall on which corrugation is subsequently implemented. The corrugation ridges are distributed along the length of the tube so as to fulfill their functions.

The goal of the present invention is to improve the devices of the prior art by proposing a device which is easier to manufacture and less costly.

In order to attain this goal, the present invention is of the type described above and it is remarkable in its broadest meaning in that at least one connector presents at least one circular corrugation ridge for absorption of vibrations.

In fact, the previously cited documents of the prior art do not disclose recirculation devices comprising connectors at their ends but rather one connector in their center.

Said tubular part advantageously presents a smooth exterior surface and does not comprise corrugated parts for the absorption of vibrations.

Said corrugation ridge(s) also advantageously extend(s) perpendicularly to the axis X of said connector and/or parallel to the axis X of said connector.

The present invention also pertains to a connector for an exhaust gas recirculation device for an internal combustion engine according to the invention.

Better understanding of the invention will be obtained from the description presented below on a purely explanatory basis of one mode of implementation of the invention with reference to the attached figures:

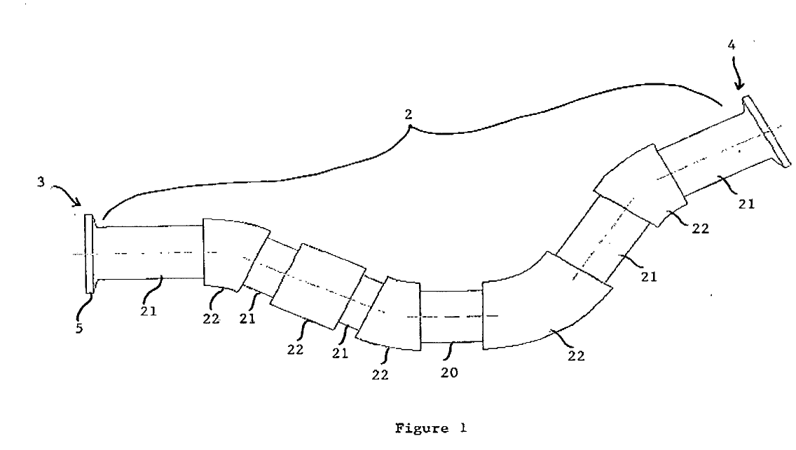

FIG. 1 illustrates a front view of an exhaust gas recirculation device for an internal combustion engine of the prior art;

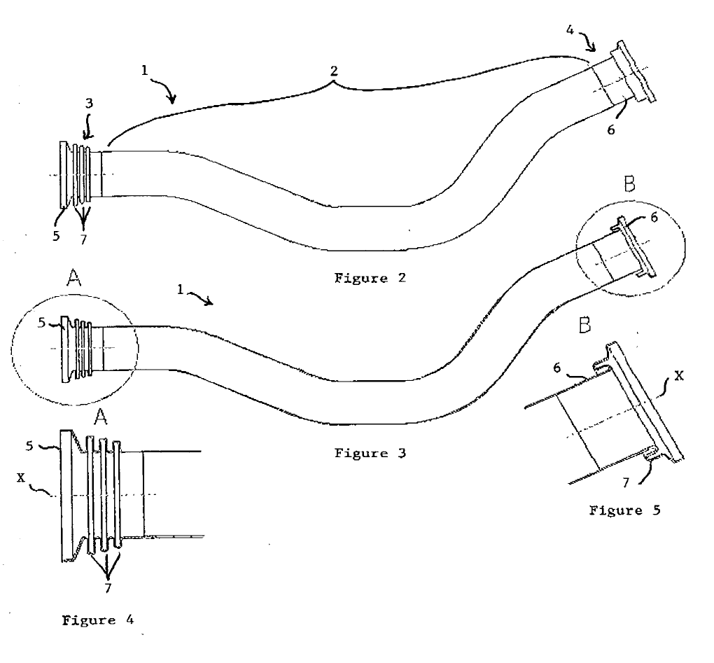

FIGS. 2 and 3 illustrate front views of an exhaust gas recirculation device for an internal combustion engine according to the invention;

FIGS. 4 and 5 illustrate detail views along A and B of FIG. 3 respectively;

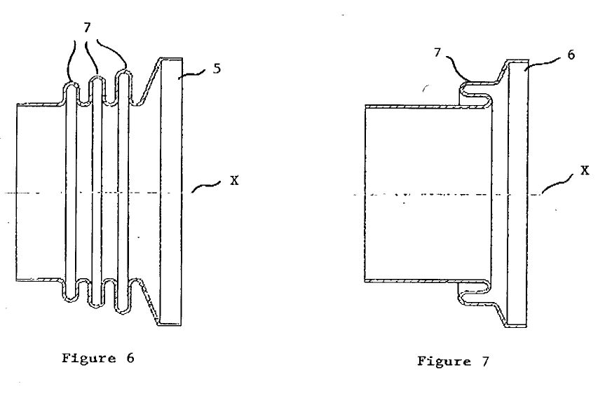

FIG. 6 illustrates a cross-sectional view of a connector with corrugation ridges extending perpendicular to said connector; and

FIG. 7 illustrates a cross-sectional view of a connector with corrugation ridges extending parallel to said connector.

An exhaust gas recirculation device for an internal combustion engine of the prior art is illustrated in FIG. 1.

This device comprises a tubular part (2) for passage of said gases and a connector (5, 6) at each of its ends (3, 4) for connecting at one end to the exhaust gas manifold (not illustrated) of the internal combustion engine and at the other end to a valve.

The tubular part (2) presents zones with essentially cylindrical plane surfaces (21) and corrugated zones (22) presenting corrugation ridges enabling bending of the tubular part (2), absorption of vibrations and providing a certain margin with regard to the total dimension and the positioning sides of the exhaust gas recirculation device.

The exhaust gas recirculation device (1) for an internal combustion engine of the type according to the invention illustrated in FIGS. 2 and 3 is characterized in that at least one connector (5, 6) presents at least one circular corrugation ridge (7) for the absorption of vibrations.

Thus, the tubular part (2) can present a smooth exterior surface and not comprise a corrugated part. The tubular part (2) then forms a smooth tube bent according to the gas pathway requirements.

One connector of the device, preferably all of the connectors of the device, present preferably a multiplicity of corrugation ridges oriented in a manner such that the projections are perpendicular and/or parallel to the axis of said connector.

FIGS. 4 and 6 illustrate a variant of the invention in which the corrugation ridges (7) extend perpendicular to the axis X of the connector (5).

FIGS. 5 and 7 illustrate a variant of the invention in which a corrugation ridge (7) extends parallel to the axis X of the connector (6).

The joining pieces forming the connectors (5, 6) can be attached to the tubular part (2), e.g., by welding.

This operation can easily be automated.

The connectors can present different sizes so as to enable attachment to different elements without requiring expensive retooling operations nor specific tooling.

Moreover, bending operations are no longer hindered by the form of the connectors or the intermediate corrugation ridges.

The invention is described above as an example. It is understood that the expert in the field could implement different variants of the invention without thereby going beyond the scope of the patent.

1. Exhaust gas recirculation device for an internal combustion engine of the type comprising a tubular part for passage of said gases and a connector at each of its ends, in which at least one connector presents at least one circular corrugation ridge for the absorption of vibrations.

2. Exhaust gas recirculation device for an internal combustion engine of the type comprising a tubular part for passage of said gases and a connector at each of its ends, in which each connector presents at least one circular corrugation ridge for the absorption of vibrations.

3. Exhaust gas recirculation device for an internal combustion engine according to claim 1, in which said tubular part does not bear circular corrugation ridges for the absorption of vibrations.

4. Exhaust gas recirculation device for an internal combustion engine according to claim 1, in which said corrugation ridge(s) extend(s) perpendicularly to the axis X of said connector.

5. Exhaust gas recirculation device for an internal combustion engine according to claim 1, in which said corrugation ridge(s) extend(s) parallel to the axis X of said connector.

6. Exhaust gas recirculation device for an internal combustion engine according to claim 3, in which said corrugation ridge(s) extend(s) parallel to the axis X of said connector.

7. Connector for an exhaust gas recirculation device for an internal combustion engine of the type comprising a tubular part for passage of said gases, said piece being designed to be positioned at one of the ends of said device, in which the connector presents at least one circular corrugation ridge for the absorption of vibrations.
